(19) United States
(12) Patent Application Publication
(10) Pub. No.: US 2003/0061133 A1
(43) Pub. Date: Mar. 27, 2003

(54) Funding an intellectual property licensing program

(76) Inventors: Arthur M. Nutter, Colorado Springs, CO (US); Ray I. Throckmorton, Hinsdale, IL (US); James R. Adams, Colorado Springs, CO (US)

Correspondence Address: Stuart T. Langley, Esq., Hogan & Hartson, LLP, Suite 1500, 1200 17th Street, Denver, CO, 80202, US

(21) Appl. No.: 10/255,127

(22) Filed: Sep. 25, 2002

Related U.S. Application Data
(60) Provisional application No. 60/324,903, filed on Sep. 25, 2001.

(51) Int. Cl. G06F 17/60

(52) U.S. Cl. 705/30; 705/31; 705/26

(57) ABSTRACT

An embodiment of the invention includes a method of funding an intellectual property licensing program that includes: selling an intellectual property asset to an entity in exchange for funds paid to a seller; licensing a right in an intellectual property asset from the entity to the seller; and funding the intellectual property licensing program with a portion of the funds form selling the intellectual property asset. Another embodiment of the invention includes an intellectual property investment entity that includes an intellectual property asset purchased from a seller in exchange for funds, where an intellectual property investment entity licenses back a right in the intellectual property asset to fund an intellectual property licensing program.

### CROSS REFERENCE TO RELATED PATENT APPLICATIONS

This application claims the benefit of U.S. Provisional Application No. 60/324,903 entitled “System and Method for Using an Intellectual Property Portfolio,” filed Sep. 25, 2001, the disclosure of which is herein specifically incorporated in its entirety by this reference.

### BACKGROUND OF THE INVENTION

1. Field of the Invention

The present invention relates, in general, to business structures for managing intellectual property, and, more specifically to the field of funding an intellectual property licensing program. Furthermore, the invention relates to intellectual property transactions, including the valuation, licensing and sale of IP assets.

2. Relevant Background

Intellectual property (IP) legal systems are intended to encourage dissemination of valuable information to the public. Inefficiencies in the practical application of these legal systems therefore inhibit this basic function and prevent knowledge from becoming available to the public. Effective and efficient management and enforcement of intellectual property rights are fundamental mechanisms by which the public benefits from the intellectual property legal systems.

Owners of intellectual property assets spend considerable time and expense procuring and maintaining these assets. Patents, for example, require up-front procurement costs as well as periodic fees to maintain their enforceability. In many instances, these costs are trivial when compared to the value of the rights that are being protected by the intellectual property asset. However, there are situations where an owner does not have the resources or the expertise to leverage fully the value of an IP asset.

For example, when a company acquires a portfolio of intellectual property assets through a merger or acquisition. It is often the case that a portion, and sometimes even all the acquired IP assets are outside the acquirer's core business. The acquirer incurs up-front costs when buying these assets, and often continues to pay throughout the lifetime of the asset in the form of periodic annuities, maintenance fees, etc. However, because the assets are outside the core business, the acquirer typically lacks the requisite expertise on how to value, license or sell them. Often, the assets are licensed or sold at less than maximum value, or neglected altogether.

One way for an owner to gain the necessary expertise in maximizing the value of an IP asset is to outsource the management of the asset to an organization that specializes in IP asset transactions. While IP asset management organizations generally add value to an IP asset well in excess of their cost, the added expense can sometimes skew an owner's financial statements to make assets appear much less valuable than they actually are.

In addition, the management of IP assets, whether outsourced or done in-house, require a significant up-front investment before an IP portfolio will begin to produce positive cash flow. Without the up-front investment to fund studies of the portfolio, market studies, and perhaps fund enforcement activities, the portfolio remains underutilized and will be unlikely to produce revenue. This stalemate situation often leads to reduced productivity and wasting of intellectual property assets.

These management/enforcement activities are often funded with borrowed capital to allow the start-up costs to be spread out over time. While tax advantages may be realized on the interest portion of the repayment of this capital, similar advantages typically do not apply to the principal portion. Consequently, the costs of funding a program for managing IP assets with borrowed capital is greater than it would be if the owner could place a greater portion of these costs in a tax advantaged category.

Further, lenders are typically less familiar with the value intellectual property as compared to more traditional assets. This makes such loans more difficult to obtain as they are perceived as having greater risk than other loans. As a result, loans that are secured by intellectual property assets may have a low loan-to-value ratio, may have higher interest rates, or other conditions that make them less attractive.

Accordingly, a need exists for systems, methods, and business processes that provide for efficiently funding an intellectual property enforcement operation or the like. Moreover, there remains a need for an investment entity that encourages efficient and cost effective management and enforcement of intellectual property portfolios.

### SUMMARY OF THE INVENTION

Accordingly, an embodiment of the invention includes a method of funding an intellectual property licensing program comprising: selling an intellectual property asset to an entity in exchange for funds paid to a seller; licensing a right in an intellectual property asset from the entity to the seller; and funding said intellectual property licensing program with a portion of the funds form selling the intellectual property asset.

Another embodiment of the invention includes an intellectual property investment entity comprising an intellectual property asset purchased from a seller in exchange for funds, wherein an intellectual property investment entity licenses back a right in the intellectual property asset to fund and intellectual property licensing program.

### BRIEF DESCRIPTION OF THE DRAWINGS

FIG. 1 shows intellectual property asset transactions according to an embodiment of the invention;

FIG. 2 shows intellectual property asset transactions according to another embodiment of the invention; and

FIG. 3 shows intellectual property asset transactions according to still another embodiment of the invention.

### DETAILED DESCRIPTION OF THE PREFERRED EMBODIMENTS

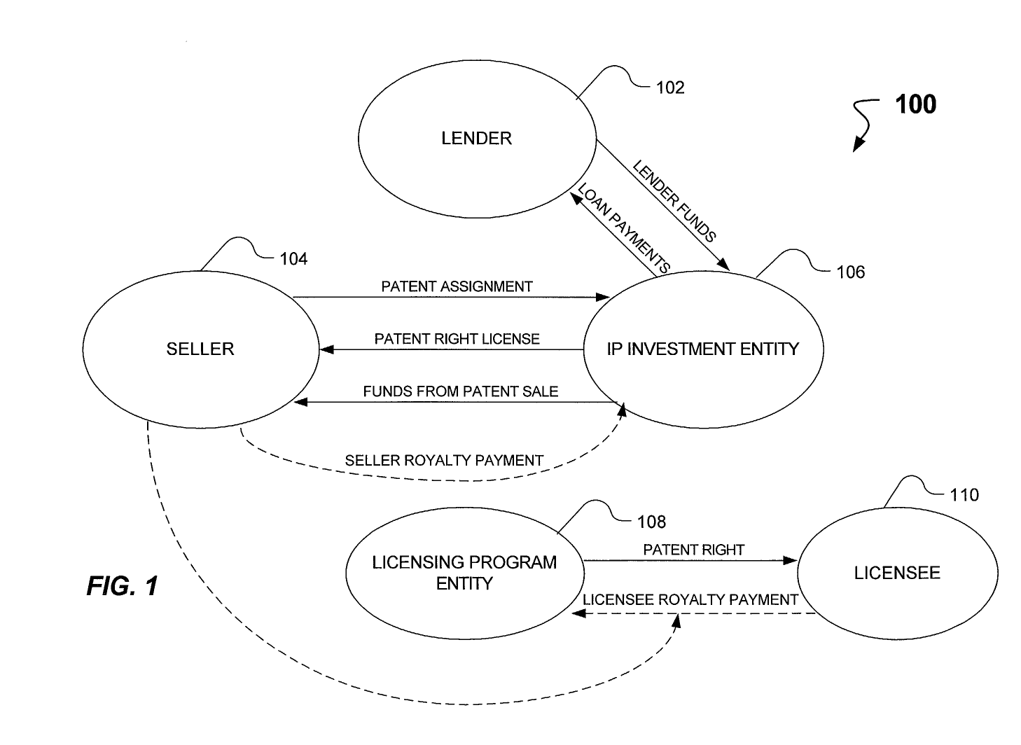

FIG. 1 shows intellectual property transactions according to an embodiment of the invention. In general, each oval in FIG. 1 represents an independent legal entity, whereas the arrows connecting the entities indicate transactions and/or relationships between the entities. Although the entities are considered independent for purposes of discussion, it is contemplated that various financial, management, control, or personnel overlap may exist between the entities without departing from the basic teachings of the present invention.

In a particular application, transaction mechanism 100 contributes to the funding of an intellectual property asset licensing program conducted by, for example, licensing program entity 108. Seller 104 initially owns an IP asset or a number of IP assets. Preferably the IP assets comprise patents, trademarks, know-how, trade secrets, copyrights, and the like. The IP assets may be undervalued when owned by seller 104 because seller 104 may not have the expertise or resources to maximize the value of the asset. In one embodiment, the IP asset may be a portfolio of patents that include, but are not limited to, United States patents, patents from countries and regions outside of the United States, patent applications, provisional patent applications, PCT applications, etc.

One aspect of the present invention enables seller 104 to use some or all of its intellectual property assets to obtain funds which may be applied against the startup costs of a patent management and/or enforcement program. Unlike traditional loan processes in which funds are provided by a lender and secured by the intellectual property assets, the present invention involves a sale of the intellectual property assets to an intellectual property investment entity 106. IP investment entity 106 may obtain funds to purchase the IP assets by way of a loan from lender 102, or may self fund the purchase transaction.

The patent portfolio may be assessed to ascertain its market value, however, lender 102 may provide lender funds to an IP investment entity 106 based in large part or exclusively on the seller royalty payment amount. In this manner the lender can deal with the transaction as nearly the same as a pure financial transaction, with which the lender is more familiar. This structure minimizes the lender's perceived risk associated with lending against intellectual property assets that it has difficulty valuing. Lender 102 may be a single lending entity or a syndicate of two or more lending entities that may have been formed by IP investment entity 106. The amount of lender funds provided to the IP investment entity may be based on the market value of the IP asset held by seller 104.

At least a portion of the lender funds may be used by the IP investment entity 106 to buy an intellectual property asset from seller 104. Lender 102 may take a security interest in the IP asset as a condition for providing the lender funds to the IP investment entity 106. The transfer of funds from lender 102 to IP investment entity 106, followed by the purchase of the IP asset from seller 104 may be completed in about 60 days or less.

After the seller 104 sells the intellectual property asset to the IP investment entity 106 in exchange for at least a portion of the lender funds, the IP investment entity 106 may license a right in the IP asset back to seller 104. In exchange for the licensed right, the seller 104 may pay a seller royalty to the IP investment entity. Rights in the IP asset include, but are not limited to, a right to use the IP in a defined field of use, a right to use the IP in a defined geographic territory, a right to sublicense the right, a right to exclusive use of the right, and a right to use the IP for a defined period of time, among other rights. The seller royalty may be a periodic payment of a predetermined amount of money. Alternatively, the seller royalty payment may be a periodic payment of a percentage of revenues that are generated through the use of the licensed right over a predetermined period of time. As yet another alternative, the seller royalty may be a mixture of a fixed payment and a percentage royalty. In this manner, the parties can allocate risk and reward very flexibly to meet the needs of a particular application.

In an embodiment, at least a portion of the royalty payment from the seller 104 to the IP investment entity 106 may be transferred to lender 102 to satisfy a loan payment. In another embodiment, lender 102 may be guaranteed at least a portion of the seller royalty payments as a condition for providing the lender funds to the IP investment entity 106. In another embodiment, seller 104 may directly transfer at least a portion of the seller royalty payments to the lender 102.

The sale of the IP asset to IP investment entity 106 followed by licensing of a right in the IP asset back to the seller 104 may be referred to as a sale/license-back transaction. These transactions may have tax advantages compared to when the seller puts up the IP asset as collateral in loan transaction. For example, in a sale/license-back transaction, substantially the whole amount of a royalty payment may be tax deductible. On the other hand, when a borrower makes a loan payment, generally the interest portion of the payment may be tax deductible, while the principal portion is not. Thus, where a seller may be entitled to a tax deduction for the full amount of a royalty payment, a borrower may only be entitled to deduct a portion of a loan payment.

A sale/license-back transaction may have other tax and accounting advantages as well. For example, since the IP asset transaction between seller 104 and the IP investment entity 106 may be structured as a sale for legal and tax purposes, the gain or loss generated by the sale of the IP asset may be used to offset the seller's gains or losses from other operations. For example, if seller 104 generates gains from the sale of an IP asset, the gains may be offset by net operating loss (NOL) carry forwards to permit at least a portion of the gains to be deductible from the seller's taxes.

The sale of the IP asset may also allow seller 104 to report the full market value of the asset in the seller's financial statements. In contrast, accounting rules, such as the generally accepted account principles (GAAP) may not permit seller 104 to recognize the full market value of an IP asset that is put up as collateral for a loan.

Seller 104 may use a portion of the lender funds received from the sale of an IP asset to fund an intellectual property licensing program. In an embodiment, seller 104 uses from about 5% to about 95% of the lender funds to fund the IP licensing program. In another embodiment, seller uses from about 10% to about 50% of the lender funds to fund the IP licensing program. In another embodiment the seller uses about 30% of the lender funds to fund the IP licensing program.

The portion of the lender funds that fund the IP licensing program may fund the program for 10 years. The lender funds may cover IP licensing program activities that include, but are not limited to, evaluating the markets for the IP asset, forensic engineering analyses, licensing negotiations, and enforcement activities. In another embodiment, funding for enforcement activities such as arbitration or litigation may be separate from the lender funds.

The IP licensing program may be conducted by seller 104, or by a licensing program entity 108. The licensing program entity 108 may be legally independent of lender 102, seller 104, and IP investment entity 106. Licensing program entity 108 may be, but is not limited to, a corporation or a limited liability company with a board of directors. The board of directors may include, but is not limited to, members from lender 102, seller 104 and/or IP investment entity 106, among others. In one embodiment, the board of directors may include specialists in IP asset valuation, strategy and licensing, among others.

In one embodiment, seller 104 may transfer the IP right to the licensing program entity 108 where the IP licensing program is conducted. In another embodiment, the IP right is transferred to licensing program entity 108 from another party, such as the IP investment entity 106. The IP right may include, without being limited to a patent right, a copyright right, a trademark right, or a trade secret right. The transfer of the IP right may be in the form of a license, a sublicense or an assignment.

Licensing program entity 108 may license the IP right to a licensee 110 in exchange for a licensee royalty payment. In one embodiment, the licensee 110 may pay a first portion of the licensee royalty payment to the licensing program entity 108 and a second portion of the licensee royalty payment to seller 104. In another embodiment, licensee 110 may pay substantially all the licensee royalty payment to the licensing program entity 108, and in another embodiment, licensee 110 may pay substantially all the licensee royalty payment to seller 104. In another embodiment, about 50% of the licensee royalty payment may go to seller 104. Management of licensee royalty payments, including the accounting and auditing of the payments, may be done by the licensing program entity 108.

It may be discovered that the valuation of an IP right proves to be worth more than was initially estimated in the valuation of the IP asset. In one embodiment, the IP right may be assigned by seller 104 in exchange for an up-front payment that may reflect the discounted future value of a licensee royalty stream. The up-front payment received by seller 104 may be used finance and/or expand the IP licensing program. In another embodiment, an up-front payment may be divided between seller 104 and licensing program entity 108.

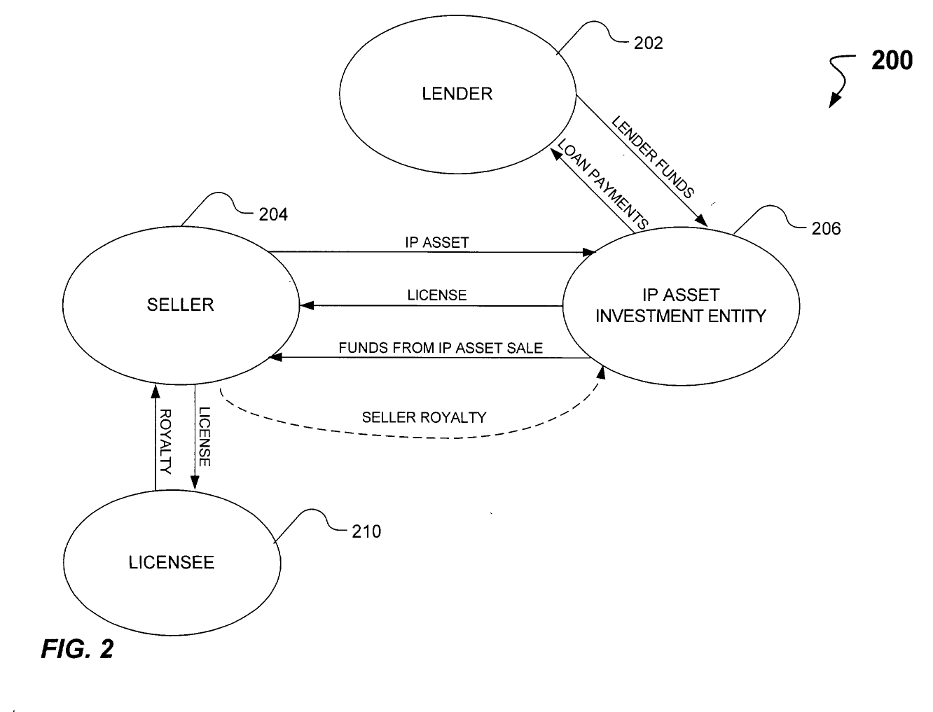

FIG. 2 shows intellectual property asset transactions according to another embodiment of the invention. In one embodiment, seller 204 may sell IP assets to an IP asset investment entity 206 in exchange for a portion of lender funds that may be provided to the IP asset investment entity 206 from lender 202. Seller 204 may then license an IP right in the IP asset from the IP asset investment entity 206. Seller 204 may pay a seller royalty for to the IP asset investment entity 206 or lender 202, or both, in exchange for the IP right.

In an embodiment shown in FIG. 2, seller 204 itself may conduct an IP licensing program rather than transfer the IP right to a licensing program entity. In this embodiment, seller 204 uses a portion of the lender funds received from the sale of an IP asset to fund an in-house IP licensing program. In an embodiment the IP licensing program may conducted within seller 204, or may be conducted in a separate division or subsidiary that is controlled by seller 204.

Seller 204 may license the IP right to licensee 210 in exchange for a licensee royalty payment. In one embodiment, the licensee 210 may pay a first portion of the licensee royalty payment to IP asset investment entity 206 or lender 202, and a second portion to seller 204. In another embodiment, licensee 210 may pay substantially all the licensee royalty payment to seller 204, and in another embodiment, licensee 210 may pay substantially all the licensee royalty payment to IP asset investment entity 206 or lender 202. In another embodiment, about 50% of the licensee royalty payment may go to seller 204. Management of licensee royalty payments, including the accounting and auditing of the payments, may be done by seller 204.

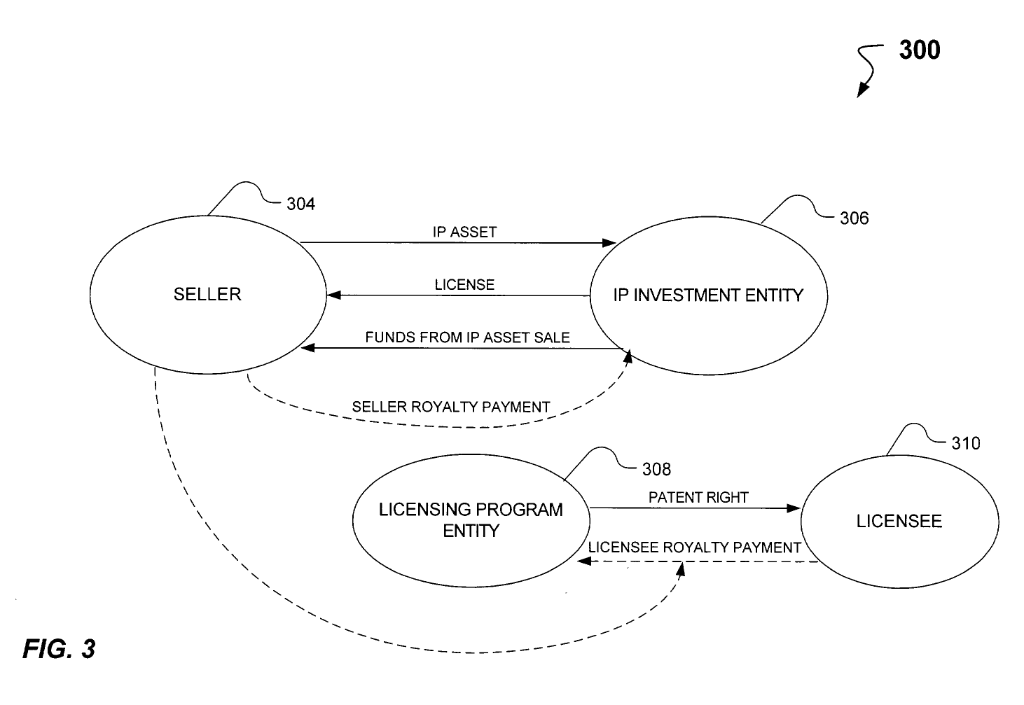

FIG. 3 shows intellectual property asset transactions according to another embodiment of the invention. In this embodiment, an IP investment entity 306 assumes the role played by a lender (not shown) in providing funds to seller 304 in exchange for an IP asset. Seller 304 may then license an IP right in the IP asset from the IP asset investment entity 306. Seller 304 may pay a seller royalty to the IP asset investment entity 306 in exchange for the IP right.

Seller 304 may then establish an IP licensing program to license the IP right. The IP licensing program may be conducted by seller 304, or by a licensing program entity 308. The licensing program entity 308 may be legally independent of seller 304 and/or IP investment entity 306.

Licensing program entity 308 may license the IP right to a licensee 310 in exchange for a licensee royalty payment. In one embodiment, the licensee 310 may pay a first portion of the licensee royalty payment to the licensing program entity 308 and a second portion of the licensee royalty payment to seller 304. In another embodiment, licensee 310 may pay substantially all the licensee royalty payment to the licensing program entity 308, and in another embodiment, licensee 310 may pay substantially all the licensee royalty payment to seller 304.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups. Furthermore, the terms “license” and “licensee” may also refer to a “sublicense” and “sublicensee,” respectively.

We claim:

1. A method of funding an intellectual property licensing program comprising:
selling an intellectual property asset to an entity in exchange for funds paid to a seller;
licensing a right in an intellectual property asset from the entity to the seller; and
funding said intellectual property licensing program with a portion of the funds from selling said intellectual property asset.

2. The method of claim 1, comprising sublicensing at least a portion of the right in the intellectual property asset by the seller to a sublicensee.

3. The method of claim 1, comprising transferring lender funds from a lender to the entity for said selling of the intellectual property asset.

4. The method of claim 3, wherein said lender funds are guaranteed by a royalty from said licensing of the right in the intellectual property asset from the entity to the seller.

5. The method of claim 3, wherein said lender comprises a bank, a venture capital fund, a corporation or a partnership.

6. The method of claim 1, wherein the right in the intellectual property asset comprises a field of use restriction.

7. The method of claim 1, wherein the right in the intellectual property asset comprises a geographical territory restriction.

8. The method of claim 1, wherein the right in the intellectual property asset comprises a right to sublicense the right.

9. The method of claim 1, wherein the right in the intellectual property asset comprises an exclusive license.

10. The method of claim 1, wherein said right comprises substantially all rights in the intellectual property asset.

11. The method of claim 1, wherein said entity comprises a corporation, a partnership, a sole proprietorship, a limited liability company, a limited liability partnership, or a limited liability limited partnership.

12. The method of claim 1, wherein the entity comprises a foreign entity established, headquartered or chartered outside the United States of America.

13. The method of claim 1, wherein said intellectual property asset comprises a patent, trademark or copyright.

14. The method of claim 1, comprising deducting from taxes of the seller costs of selling of the intellectual property asset to the entity.

15. The method of claim 1, comprising deducting from taxes of the seller costs of licensing the right in the intellectual property asset from the entity.

16. The method of claim 1, wherein said selling of the intellectual property asset by the seller comprises recognition as a sale of the intellectual property asset under generally accepted accounting principles.

17. An intellectual property investment entity comprising an intellectual property asset purchased from a seller in exchange for funds, wherein an intellectual property investment entity licenses back a right in the intellectual property asset to the seller, and wherein a portion of the funds intellectual property asset are used to fund an intellectual property licensing program.

18. The intellectual property investment entity of claim 17, wherein the purchase of the intellectual property asset from the seller comprises a requirement that the seller fund at least a portion of the intellectual property licensing program.

19. The intellectual property investment entity of claim 17, wherein the intellectual property asset comprises a patent.

20. The intellectual property investment entity of claim 17, wherein the right in the intellectual property comprises at least one of: a field of use restriction, a geographical territory restriction, a right to sublicense, or an exclusive license.
